(19) United States
(12) Patent Application Publication
(10) Pub. No.: US 2010/0323717 A1
(43) Pub. Date: Dec. 23, 2010

(54) METHOD AND APPARATUS FOR FACILITATING PROXIMITY DETECTION IN A WIRELESS NETWORK

(75) Inventors: Parag Arun Agashe, San Diego, CA (US); Ravi Palanki, San Diego, CA (US); Tingfang Ji, San Diego, CA (US); Naga Bhushan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/761,224

(22) Filed: Apr. 15, 2010

Related U.S. Application Data
(60) Provisional application No. 61/219,504, filed on Jun. 23, 2009.

(51) Int. Cl. H04W 24/00

(52) U.S. Cl. 455/456.1

(57) ABSTRACT

Methods, apparatuses, and computer program products are disclosed for facilitating proximity detection in wireless networks. a location enhancement device is activated and a unique identifier associated with the location enhancement device is ascertained. A positioning signal that emulates a base station reference signal is then generated, which includes the unique identifier. The positioning signal is transmitted from the location enhancement device, wherein the positioning signal is detectable by wireless terminals proximate to the location enhancement device. Proximity detection is then facilitated by processing the positioning signal.

### CROSS-REFERENCE TO RELATED APPLICATIONS

This application claims the benefit of U.S. Provisional Patent Application Ser. No. 61/219,504 entitled “Method and Apparatus for Facilitating Proximity Detection in a Wireless Network,” which was filed Jun. 23, 2009. The aforementioned application is herein incorporated by reference in its entirety.

### BACKGROUND

I. Field

The following description relates generally to wireless communications, and more particularly to methods and apparatuses for facilitating proximity detection in a wireless network.

II. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

In cellular deployments, positioning may be ascertained based on “Observed Time Difference of Arrival” (OTDOA) measurements from the cellular base stations (e.g., eNode Bs). For instance, the latitude and longitude coordinates of the base stations, along with the OTDOA measurements may be used to estimate the position of the user equipment (UE). This computation may be done either at the UE or at a positioning server. Such techniques, however, provide only a certain amount of accuracy, and may also not work indoors due to limited cellular coverage. Accordingly, it would be desirable to develop a method and apparatus for efficiently facilitating proximity detection in a manner that overcomes these limitations.

The above-described deficiencies of current wireless communication systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with locating a wireless terminal In one aspect, methods and computer program products are disclosed that facilitate proximity detection in a wireless communication network. Within such embodiments, a location enhancement device is activated and a unique identifier associated with the location enhancement device is ascertained. A positioning signal is then generated that emulates a base station reference signal. For these embodiments, the positioning signal includes the unique identifier. The positioning signal is then transmitted from the location enhancement device.

In another aspect, an apparatus configured to facilitate proximity detection is disclosed. Within such embodiment, the apparatus includes a processor configured to execute computer executable components stored in memory. The computer executable components include an activation component, an identifier component, a generation component, and a communication component. The activation component is configured to activate a location enhancement device, whereas the identifier component is configured to determine a unique identifier associated with the location enhancement device. For this embodiment, the generation component is configured to provide a positioning signal that emulates a base station reference signal and includes the unique identifier. The communication component is then configured to broadcast the positioning signal from the location enhancement device.

In a further aspect, another apparatus is disclosed. Within such embodiment, the apparatus includes means for activating, means for associating, means for imitating, and means for broadcasting. For this embodiment, the means for activating activates a location enhancement device, whereas the means for associating associates a unique identifier with the location enhancement device. The means for imitating imitates a base station reference signal with a positioning signal, which includes the unique identifier. The means for broadcasting then broadcasts the positioning signal from the location enhancement device. Here, the location enhancement device may be one of a plurality of location enhancement devices including the location enhancement device and at least one additional location enhancement device. Within such embodiment, the means for activating depends on an activation of the at least one additional location enhancement device.

In another aspect, other methods and computer program products are disclosed for facilitating proximity detection. For such embodiments, a positioning signal is generated and an algorithm is implemented to facilitate determining a wireless terminal location. Here, the algorithm is configured to determine a transmit power and direction for the positioning signal. The positioning signal is then transmitted according to the transmit power and the direction.

Another apparatus for facilitating proximity detection is also disclosed. Within such embodiment, the apparatus includes a processor configured to execute computer executable components stored in memory. The computer executable components include a generation component, an algorithm component, and a communication component. The generation component is configured to create a positioning signal. The algorithm component is configured to implement an algorithm to ascertain a transmit power and a direction, wherein the algorithm is configured to facilitate determining a wireless terminal location. The communication component is then configured to broadcast the positioning signal based on the transmit power and the direction.

In a further aspect, another apparatus is disclosed. Within such embodiment, the apparatus includes means for creating, means for implementing, and means for broadcasting. For this embodiment, means for creating creates a positioning signal, whereas the means for implementing implements an algorithm to determine a transmit power and direction for the positioning signal. Here, the algorithm is configured to facilitate locating a wireless terminal The means for broadcasting then broadcasts the positioning signal based on the transmit power and the direction. For some embodiments, the means for broadcasting includes at least one of a directional antenna or a rotational antenna.

In other aspects, methods and computer program products are disclosed for facilitating proximity detection from a wireless terminal Within such embodiments, a positioning signal emulating a base station reference signal is received from a location enhancement device. A unique identifier associated with the location enhancement device is then extracted from the positioning signal, and a set of transmission characteristics associated with the positioning signal is ascertained. A location determination is then facilitated based on at least one of the unique identifier or the set of transmission characteristics.

An apparatus configured to facilitate proximity detection from a wireless terminal is also disclosed. Within such embodiment, the apparatus includes a processor configured to execute computer executable components stored in memory. The computer executable components include a receiving component, an extraction component, a measurement component, and a transmitting component. The receiving component is configured to receive a positioning signal that emulates a base station reference signal from a location enhancement device. The extraction component is configured to obtain a unique identifier associated with the location enhancement device from the positioning signal, whereas the measurement component is configured to ascertain a set of transmission characteristics associated with the positioning signal. The transmitting component is then configured to transmit at least one of the unique identifier or the set of transmission characteristics to facilitate determining a location.

In a further aspect, another apparatus is disclosed. Within such embodiment, the apparatus includes means for detecting a positioning signal, means for extracting, means for measuring, and means for communicating. For this embodiment, the positioning signal emulates a base station reference signal and is broadcast by a location enhancement device. The means for extracting extracts a unique identifier associated with the location enhancement device from the positioning signal, whereas the means for measuring measures a set of transmission characteristics associated with the positioning signal. The means for communicating is a means for communicating at least one of the unique identifier or the set of transmission characteristics.

In yet another aspect, other methods and computer program products are disclosed for facilitating proximity detection from a wireless terminal Within such embodiments, a positioning signal is detected and a received transmission power of the positioning signal is ascertained. A characteristic associated with a direction of the positioning signal is then extracted from the positioning signal. A location determination is then facilitated, wherein the location determination is based on the characteristic and the received transmission power.

Another apparatus for facilitating proximity detection from a wireless terminal is also disclosed. Within such embodiment, the apparatus includes a processor configured to execute computer executable components stored in memory. The computer executable components include a communication component, a power component, an extraction component, and a location component. The communication component is configured to receive a positioning signal, whereas the power component is configured to determine a received transmission power of the positioning signal. The extraction component is configured to extract at least one characteristic from the positioning signal associated with a direction of the positioning signal. The location component is then configured to locate a wireless terminal based on the at least one characteristic and the received transmission power.

In a further aspect, yet another apparatus is disclosed. Within such embodiment, the apparatus includes means for detecting a positioning signal, means for determining, means for ascertaining, and means for locating. For this embodiment, the means for determining determines a received transmission power of the positioning signal, whereas the means for ascertaining ascertains at least one characteristic from the positioning signal associated with a direction of the positioning signal. The means for locating then locates a wireless terminal based on the at least one characteristic and the received transmission power. In an aspect, the apparatus may further includes means for associating the at least one characteristic with at least one of a directional antenna or a rotational antenna.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an exemplary wireless network environment that can be employed in conjunction with the various systems and methods described herein.

FIG. 3 illustrates an exemplary communication system that enables deployment of access point base stations within a network environment.

FIG. 4 is an illustration of an exemplary system for facilitating proximity detection in a wireless network according to an embodiment.

FIG. 5 is an illustration of an exemplary hierarchy of location enhanced devices for facilitating proximity detection in a wireless network.

FIG. 6 is a flow chart illustrating an exemplary methodology for facilitating proximity detection in accordance with an aspect of the subject specification.

FIG. 7 illustrates a block diagram of an exemplary location enhancement device that facilitates proximity detection in accordance with an aspect of the subject specification.

FIG. 8 is an illustration of a first exemplary coupling of electrical components that effectuate facilitating proximity detection.

FIG. 9 illustrates a block diagram of an exemplary wireless terminal that facilitates proximity detection in accordance with an aspect of the subject specification.

FIG. 10 is an illustration of a second exemplary coupling of electrical components that effectuate facilitating proximity detection.

FIG. 11 is an illustration of an exemplary configuration of directional location enhanced devices for facilitating proximity detection in a wireless network.

FIG. 12 is an illustration of an exemplary configuration of rotational location enhanced devices for facilitating proximity detection in a wireless network.

FIG. 13 is another flow chart illustrating an exemplary methodology for facilitating proximity detection in accordance with an aspect of the subject specification.

FIG. 14 illustrates a block diagram of an exemplary network element that facilitates proximity detection in accordance with an aspect of the subject specification.

FIG. 15 is an illustration of a third exemplary coupling of electrical components that effectuate facilitating proximity detection.

FIG. 16 illustrates a block diagram of an exemplary wireless terminal that facilitates proximity detection in accordance with an aspect of the subject specification.

FIG. 17 is an illustration of a fourth exemplary coupling of electrical components that effectuate facilitating proximity detection.

FIG. 18 is an illustration of an exemplary communication system implemented in accordance with various aspects including multiple cells.

FIG. 19 is an illustration of an exemplary base station in accordance with various aspects described herein.

FIG. 20 is an illustration of an exemplary wireless terminal implemented in accordance with various aspects described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The subject specification is directed towards facilitating proximity detection in a wireless communication network. In an aspect, proximity detection is facilitated by deploying location enhancement devices (in addition to base stations), which transmit a positioning signal detectable by cellular UEs. In various embodiments, the positioning signal may be a positioning reference signal (PRS), a synchronization signal (e.g., a primary synchronization signal (PSS), a secondary synchronization signal (SSS), etc.), or a common reference signal (CRS). The use of a PRS-only device (which, for example, may not provide voice/data services) provides a lower cost alternative compared to a full-fledged access point base station (which may provide voice/data services), and also limits the interference caused to regular cellular communications. Furthermore, these positioning signals could be transmitted with a low duty cycle in time/frequency in order to reduce the pollution. The location enhanced devices could also declare themselves to be restricted association devices so that UEs do not attempt to connect to them for data services.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), High Speed Packet Access (HSPA), and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

High speed packet access (HSPA) can include high speed downlink packet access (HSDPA) technology and high speed uplink packet access (HSUPA) or enhanced uplink (EUL) technology and can also include HSPA+ technology. HSDPA, HSUPA and HSPA+ are part of the Third Generation Partnership Project (3GPP) specifications Release 5, Release 6, and Release 7, respectively.

High speed downlink packet access (HSDPA) optimizes data transmission from the network to the user equipment (UE). As used herein, transmission from the network to the user equipment UE can be referred to as the “downlink” (DL). Transmission methods can allow data rates of several Mbits/s. High speed downlink packet access (HSDPA) can increase the capacity of mobile radio networks. High speed uplink packet access (HSUPA) can optimize data transmission from the terminal to the network. As used herein, transmissions from the terminal to the network can be referred to as the “uplink” (UL). Uplink data transmission methods can allow data rates of several Mbit/s. HSPA+ provides even further improvements both in the uplink and downlink as specified in Release 7 of the 3GPP specification. High speed packet access (HSPA) methods typically allow for faster interactions between the downlink and the uplink in data services transmitting large volumes of data, for instance Voice over IP (VoIP), videoconferencing and mobile office applications

Fast data transmission protocols such as hybrid automatic repeat request, (HARQ) can be used on the uplink and downlink. Such protocols, such as hybrid automatic repeat request (HARQ), allow a recipient to automatically request retransmission of a packet that might have been received in error.

Various embodiments are described herein in connection with an access terminal An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB), access point base station, or some other terminology.

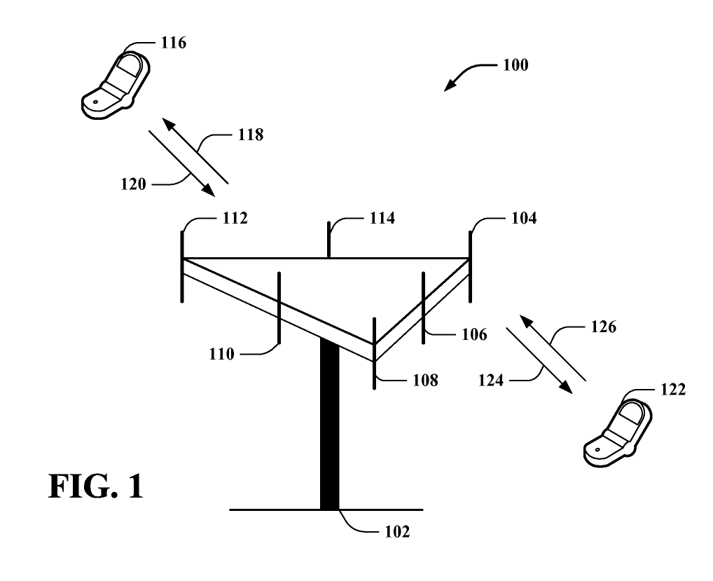

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more access terminals such as access terminal 116 and access terminal 122; however, it is to be appreciated that base station 102 can communicate with substantially any number of access terminals similar to access terminals 116 and 122. Access terminals 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, access terminal 116 is in communication with antennas 112 and 114, where antennas 112 and 114 transmit information to access terminal 116 over a forward link 118 and receive information from access terminal 116 over a reverse link 120. Moreover, access terminal 122 is in communication with antennas 104 and 106, where antennas 104 and 106 transmit information to access terminal 122 over a forward link 124 and receive information from access terminal 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to access terminals in a sector of the areas covered by base station 102. In communication over forward links 118 and 124, the transmitting antennas of base station 102 can utilize beamforming to improve signal-to-noise ratio of forward links 118 and 124 for access terminals 116 and 122. Also, while base station 102 utilizes beamforming to transmit to access terminals 116 and 122 scattered randomly through an associated coverage, access terminals in neighboring cells can be subject to less interference as compared to a base station transmitting through a single antenna to all its access terminals.

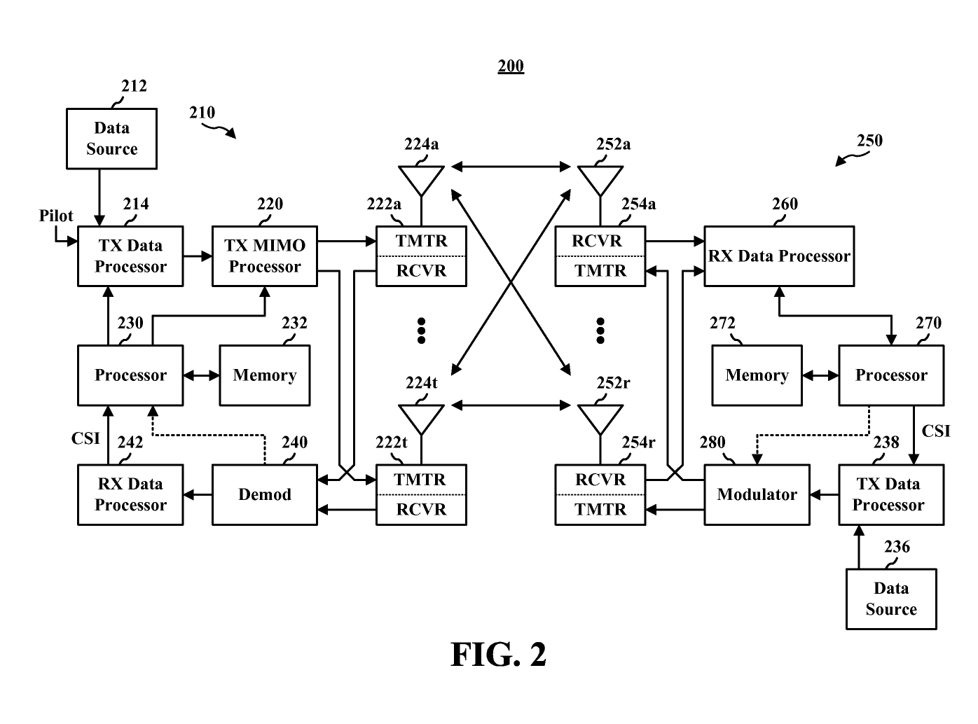

FIG. 2 shows an example wireless communication system 200. The wireless communication system 200 depicts one base station 210 and one access terminal 250 for sake of brevity. However, it is to be appreciated that system 200 can include more than one base station and/or more than one access terminal, wherein additional base stations and/or access terminals can be substantially similar or different from example base station 210 and access terminal 250 described below. In addition, it is to be appreciated that base station 210 and/or access terminal 250 can employ the systems and/or methods described herein to facilitate wireless communication there between.

At base station 210, traffic data for a number of data streams is provided from a data source 212 to a transmit (TX) data processor 214. According to an example, each data stream can be transmitted over a respective antenna. TX data processor 214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides N_{T} modulation symbol streams to N_{T} transmitters (TMTR) 222a through 222t. In various embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 222a through 222t are transmitted from N_{T} antennas 224a through 224t, respectively.

At access terminal 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective signal, digitizes the conditioned signal to provide samples, and further processes the samples to provide a corresponding “received” symbol stream.

An RX data processor 260 can receive and process the N_{R} received symbol streams from N_{R} receivers 254 based on a particular receiver processing technique to provide N_{T} “detected” symbol streams. RX data processor 260 can demodulate, deinterleave, and decode each detected symbol stream to recover the traffic data for the data stream. The processing by RX data processor 260 is complementary to that performed by TX MIMO processor 220 and TX data processor 214 at base station 210.

A processor 270 can periodically determine which available technology to utilize as discussed above. Further, processor 270 can formulate a reverse link message comprising a matrix index portion and a rank value portion.

The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from access terminal 250 are received by antennas 224, conditioned by receivers 222, demodulated by a demodulator 240, and processed by a RX data processor 242 to extract the reverse link message transmitted by access terminal 250. Further, processor 230 can process the extracted message to determine which precoding matrix to use for determining the beamforming weights.

Processors 230 and 270 can direct (e.g., control, coordinate, manage, etc.) operation at base station 210 and access terminal 250, respectively. Respective processors 230 and 270 can be associated with memory 232 and 272 that store program codes and data. Processors 230 and 270 can also perform computations to derive frequency and impulse response estimates for the uplink and downlink, respectively.

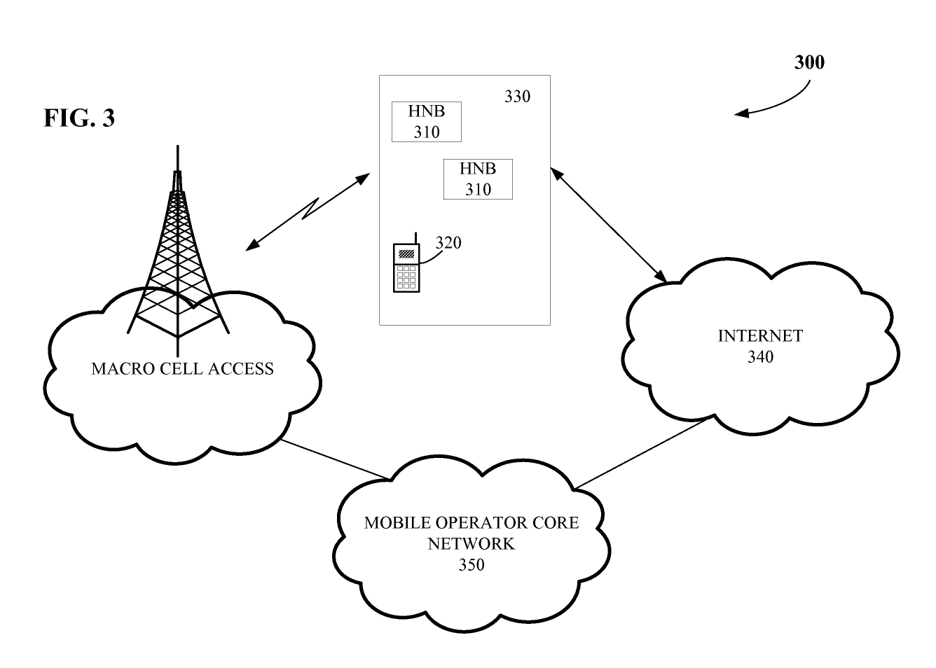

FIG. 3 illustrates an exemplary communication system to enable deployment of access point base stations within a network environment. As shown in FIG. 3, the system 300 includes multiple access point base stations or, in the alternative, femto cells, Home Node B units (HNBs), or Home evolved Node B units (HeNBs), such as, for example, HNBs 310, each being installed in a corresponding small scale network environment, such as, for example, in one or more user residences 330, and being configured to serve associated, as well as alien, user equipment (UE) or mobile stations 320. Each HNB 310 is further coupled to the Internet 340 and a mobile operator core network 350 via a DSL router (not shown) or, alternatively, a cable modem (not shown).

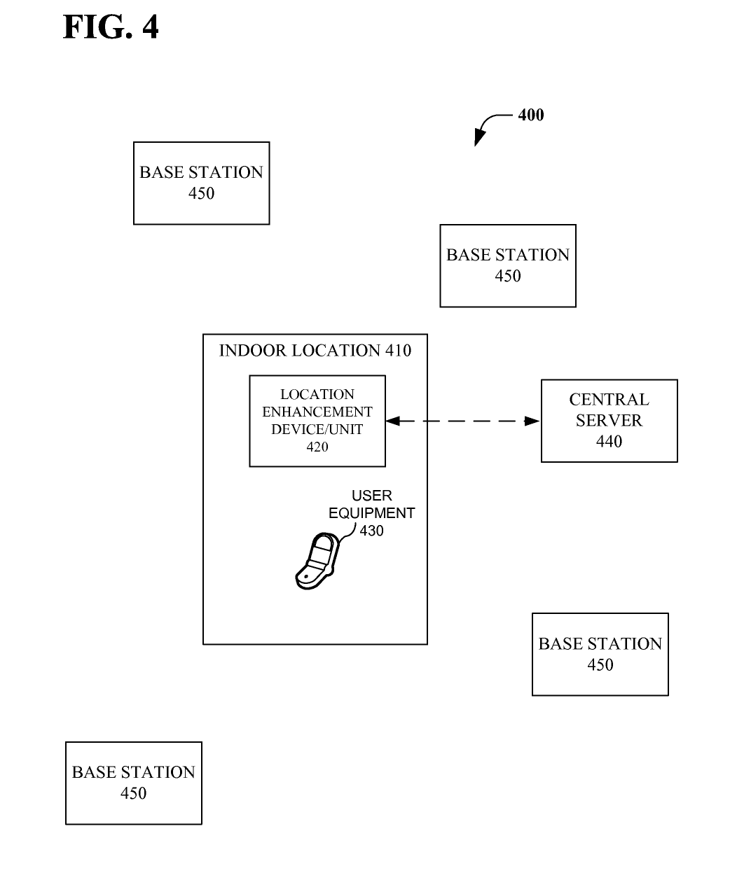

Referring next to FIG. 4, an exemplary system for facilitating proximity detection according to an embodiment is provided. As illustrated, system 400 includes a plurality of base stations 450 within various proximities to an indoor location 410. For this particular example, user equipment 430 is within indoor location 410, wherein indoor location 410 is configured to include at least one location enhancement device 420. Here, it should be noted that location enhancement device(s) 420 may be a single device or a unit comprising a plurality of location enhancement devices (such devices may be used in other technologies as well, for example, a WiFi transmitter may be used). Additionally, as shown, location enhancement device(s) 420 may be configured to communicate with a centralized server 440. For such embodiments, location enhancement device(s) 420 may include a wired or wireless backhaul to communicate with central server 440. In the wireless case, a cellular user equipment or a WiFi chip may be integrated into location enhancement device(s) 420.

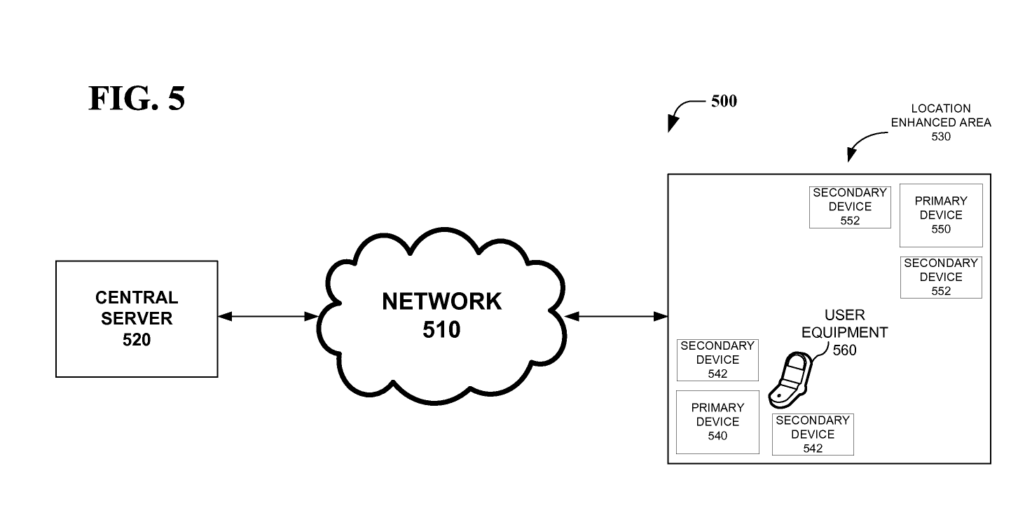

In another aspect, it should also be appreciated that location enhancement device(s) may be deployed in a hierarchical manner, as illustrated in FIG. 5. In this exemplary embodiment, various primary devices 540, 550 and secondary devices 542, 552, within a location enhanced area 530 are controlled by a central server 520 via a network 510 (note: network 510 may be wired or wireless). For instance, during operation primary location enhanced devices 540 and 550 may be activated all the time, which allows for a coarse positioning estimate of user equipment 560 to be obtained. This estimate could then be used by central server 520 to respectively activate secondary devices 542 and 552 to further enhance the positioning estimate (assuming secondary devices 542 and 552 are also location enhancing devices). For example, secondary devices 542 may be activated here since user equipment 560 is closer to primary device 540, whereas secondary devices 552 might remain dormant. It should also be appreciated that secondary devices 542 and 552 do not necessarily have to be location enhancing devices (i.e., secondary devices 542 and/or 552 can be any device that can provide a specific service user equipment 560 desires).

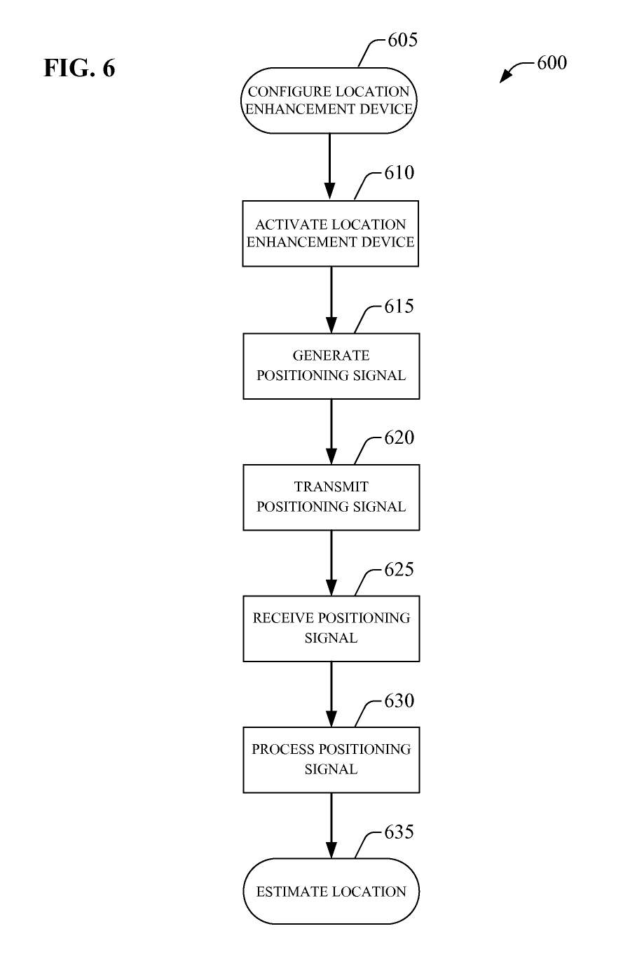

Referring next to FIG. 6, a flow chart illustrating an exemplary method for facilitating proximity detection is provided. As illustrated, process 600 includes a series of acts that may be performed by various components of a wireless network according to an aspect of the subject specification. Process 600 may be implemented by employing at least one processor to execute computer executable instructions stored on a computer readable storage medium to implement the series of acts. In another embodiment, a computer-readable storage medium comprising code for causing at least one computer to implement the acts of process 600 are contemplated.

In an aspect, process 600 begins with the configuration of a location enhancement device at act 605. Here, it should be noted that the location enhancement device may be self-configured and/or configured by an external entity. For instance, the location enhancement device may be communicatively coupled to a server, wherein the location enhancement device is configured by a network entity.

Next, at act 610, the location enhancement device is activated. In an aspect, such activation may be triggered by any of various events. For instance, in a particular embodiment, the activation is triggered upon detecting that a neighboring location enhancement device has been activated. Indeed, the location enhancement device may be part of a mini-network of location enhancement devices, wherein individual activations may depend on activations of other location enhancement devices in the network. Such activations may also be triggered by other events such as an activation of a neighboring access point base station and/or an explicit command received from a network entity.

Once the location enhancement device is activated, process 600 proceeds to act 615 where a positioning signal is generated. In an aspect, as stated previously, such positioning signal emulates a base station reference signal and can be any of a plurality of signal types. For instance, the positioning signal may emulate any of a positioning reference signal, a synchronization signal, a common reference signal, or a system information block (SIB). The positioning signal is then transmitted at act 620.

Process 600 then continues at act 625 where the transmitted positioning signal is received by a wireless terminal Upon receiving the positioning signal, the wireless terminal proceeds by processing the positioning signal at act 630. Here, it should be noted that such processing may include extracting a unique identifier embedded within the positioning signal, as well as taking power measurements of the positioning signal. Process 600 then concludes at act 635 where a location of the wireless terminal is estimated based on characteristics of the positioning signal ascertained at act 630. Here, it should be noted that the location estimation can be performed locally at the wireless terminal and/or at a base station serving the wireless terminal

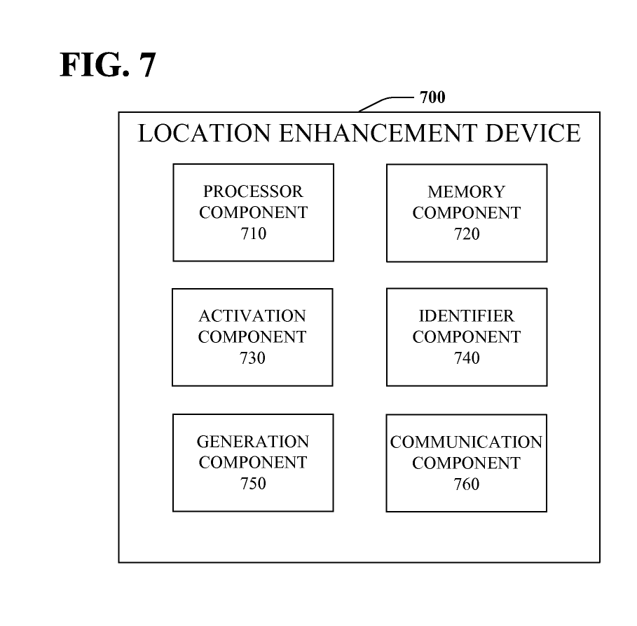

Referring next to FIG. 7, a block diagram of an exemplary location enhancement device that facilitates proximity detection according to an embodiment is provided. As shown, location enhancement device 700 may include processor component 710, memory component 720, activation component 730, identifier component 740, generation component 750, and communication component 760.

In one aspect, processor component 710 is configured to execute computer-readable instructions related to performing any of a plurality of functions. Processor component 710 can be a single processor or a plurality of processors dedicated to analyzing information to be communicated from location enhancement device 700 and/or generating information that can be utilized by memory component 720, activation component 730, identifier component 740, generation component 750, and/or communication component 760. Additionally or alternatively, processor component 710 may be configured to control one or more components of location enhancement device 700.

In another aspect, memory component 720 is coupled to processor component 710 and configured to store computer-readable instructions executed by processor component 710. Memory component 720 may also be configured to store any of a plurality of other types of data including algorithms for collecting beacon signal data, as well as data generated by any of activation component 730, identifier component 740, generation component 750, and/or communication component 760. Memory component 720 can be configured in a number of different configurations, including as random access memory, battery-backed memory, hard disk, magnetic tape, etc. Various features can also be implemented upon memory component 720, such as compression and automatic back up (e.g., use of a Redundant Array of Independent Drives configuration).

As illustrated, location enhancement device 700 also includes activation component 730. Within such embodiment, activation component 730 is configured to activate location enhancement device 700. In an aspect, it should be noted that location enhancement device 700 may be configured to operate as part of a plurality of location enhancement devices. For instance, the plurality of location enhancement devices may include location enhancement device 700 and at least one additional location enhancement device. For such embodiment, activation component 730 may be configured to have an activation of location enhancement device 700 depend on a prior activation of the at least one additional location enhancement device. Similarly, activation of the additional location enhancement device may depend on an activation of location enhancement device 700.

In another aspect, location enhancement device 700 also includes identifier component 740 and generation component 750. For this embodiment, identifier component 740 is configured to determine a unique identifier associated with location enhancement device 700, whereas generation component 750 is configured to generate a positioning signal which includes the unique identifier and emulates a base station reference signal. Here, it is noted that the positioning signal provided by generation component 750 can emulate any of a plurality of types of signals broadcast from a base station. For instance, the positioning signal can be any of a positioning reference signal, a synchronization signal, a common reference signal, or a system information block (SIB).

In a further aspect, location enhancement device 700 includes communication component 760, which is coupled to processor component 710 and configured to interface location enhancement device 700 with external entities. For instance, communication component 760 may be configured to broadcast the positioning signal generated by generation component 750. In a particular embodiment, communication component 760 is further configured to facilitate a server communication between location enhancement device 700 and a server. For this embodiment, it should be noted that communication component 760 may be configured to facilitate the server communication via either of a wireless communication system and/or a wired communication system.

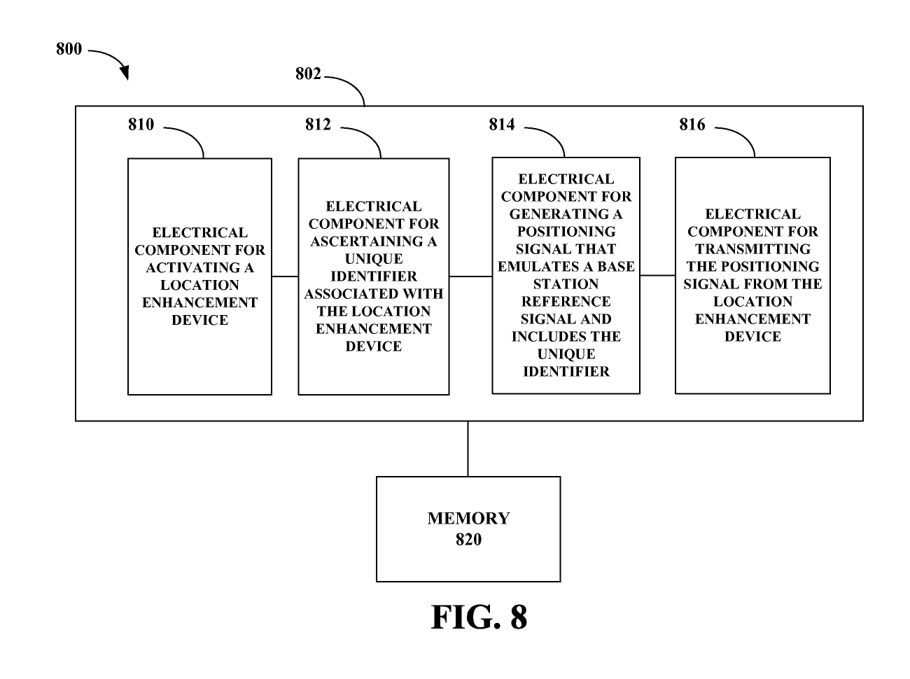

Turning to FIG. 8, illustrated is a system 800 that facilitates proximity detection according to an embodiment. System 800 and/or instructions for implementing system 800 can reside within a location enhancement device (e.g., location enhancement device 700) or a computer-readable storage medium, for instance. As depicted, system 800 includes functional blocks that can represent functions implemented by a processor, software, or combination thereof (e.g., firmware). System 800 includes a logical grouping 802 of electrical components that can act in conjunction. As illustrated, logical grouping 802 can include an electrical component for activating a location enhancement device 810, as well as an electrical component for ascertaining a unique identifier associated with the location enhancement device 812. Logical grouping 802 can also include an electrical component for generating a positioning signal that emulates a base station reference signal and includes the unique identifier 814. Further, logical grouping 802 can include an electrical component for transmitting the positioning signal from the location enhancement device 816. Additionally, system 800 can include a memory 820 that retains instructions for executing functions associated with electrical components 810, 812, 814, and 816, wherein any of electrical components 810, 812, 814, and 816 can exist either within or outside memory 820.

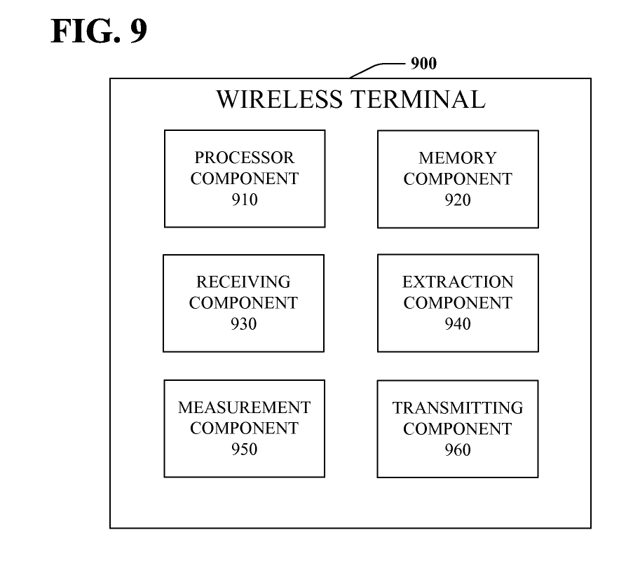

Referring next to FIG. 9, a block diagram illustrates an exemplary wireless terminal that facilitates proximity detection in accordance with various aspects. As illustrated, wireless terminal 900 may include processor component 910, memory component 920, receiving component 930, extraction component 940, measurement component 950, and transmitting component 960.

Similar to processor component 710 in location enhancement device 700, processor component 910 is configured to execute computer-readable instructions related to performing any of a plurality of functions. Processor component 910 can be a single processor or a plurality of processors dedicated to analyzing information to be communicated from wireless terminal 900 and/or generating information that can be utilized by memory component 920, receiving component 930, extraction component 940, measurement component 950, and/or transmitting component 960. Additionally or alternatively, processor component 910 may be configured to control one or more components of wireless terminal 900.

In another aspect, memory component 920 is coupled to processor component 910 and configured to store computer-readable instructions executed by processor component 910. Memory component 920 may also be configured to store any of a plurality of other types of data including data generated by any of receiving component 930, extraction component 940, measurement component 950, and/or transmitting component 960. Here, it should be noted that memory component 920 is analogous to memory component 720 in location enhancement device 700. Accordingly, it should be appreciated that any of the aforementioned features/configurations of memory component 720 are also applicable to memory component 920.

In yet another aspect, receiving component 930 and transmitting component 960 are also coupled to processor component 910 and configured to interface wireless terminal 900 with external entities. For instance, receiving component 930 may be configured to receive a positioning signal that emulates a base station reference signal (e.g., from a location enhancement device), whereas transmitting component 960 may be configured to transmit any of various types of data to facilitate determining a location of wireless terminal 900. For instance, transmitting component 960 may be configured to transmit a unique identifier embedded within a received positioning signal and/or a set of transmission characteristics associated with the received positioning signal. In a particular embodiment, transmitting component 960 is configured to provide the unique identifier and/or set of transmission characteristics to a base station, wherein receiving component 930 is then configured to receive an approximate location for wireless terminal 900 from the base station.

In another aspect, wireless terminal 900 also includes extraction component 940 and measurement component 950. For this embodiment, extraction component 940 is configured to extract a unique identifier associated with a particular location enhancement device from the received positioning signal, whereas measurement component 950 is configured to ascertain a set of transmission characteristics associated with the positioning signal (e.g., received power measurements).

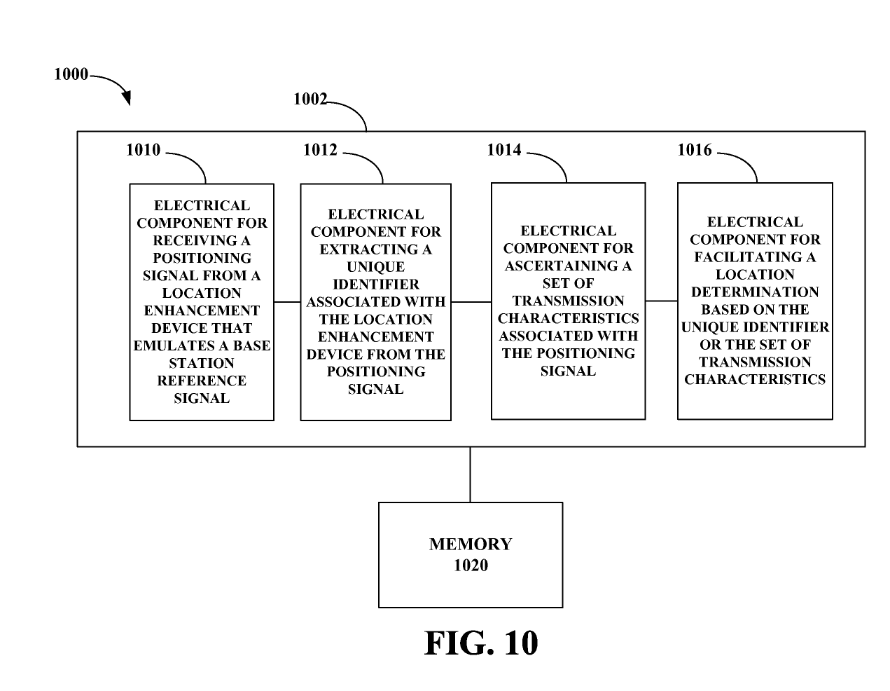

Referring next to FIG. 10, illustrated is a system 1000 that facilitates proximity detection from a wireless terminal according to an embodiment. System 1000 and/or instructions for implementing system 1000 can reside within a wireless terminal (e.g., wireless terminal 900) or a computer-readable storage medium, for instance, wherein system 1000 includes functional blocks that can represent functions implemented by a processor, software, or combination thereof (e.g., firmware). Moreover, system 1000 includes a logical grouping 1002 of electrical components that can act in conjunction similar to logical grouping 802 in system 800. As illustrated, logical grouping 1002 can include an electrical component for receiving a positioning signal from a location enhancement device that emulates a base station reference signal 1010, as well as an electrical component for extracting a unique identifier associated with the location enhancement device from the positioning signal 1012. Logical grouping 1002 can also include an electrical component for ascertaining a set of transmission characteristics associated with the positioning signal 1014. Further, logical grouping 1002 can include an electrical component for facilitating a location determination based on the unique identifier or the set of transmission characteristics 1016. Additionally, system 1000 can include a memory 1020 that retains instructions for executing functions associated with electrical components 1010, 1012, 1014, and 1016. While shown as being external to memory 1020, it is to be understood that electrical components 1010, 1012, 1014, and 1016 can exist within memory 1020.

In another aspect, it has been found that, for location enhancement devices (as well as other devices such as HeNBs and peer-to-peer transmitters that could be used for positioning), there is a tradeoff between coverage and location accuracy based on radio frequency distance. In general, the smaller the transmit power, the better the proximity one gets at the cost of coverage. This transmit power could be set in different ways.

For instance, in a first embodiment, transmit power control may be based on application. For example, a vending machine may have a coverage of 90 decibel (dB) path-loss; an exit sign on highway may have a coverage of 120 dB path-loss, etc. In a second embodiment, transmit power may be oscillated. For instance, the transmit power of such peer-to-peer or location enhancement devices could be controlled to have some patterns to tradeoff the coverage and accuracy. For example, some periodical pattern could be used such that different UEs get different location accuracy. In a third embodiment, transmit power advertisement may be utilized. Within such embodiment, in addition to, or as an alternative to transmit power control, the transmit power could be advertised allowing for the UE to estimate the path loss.

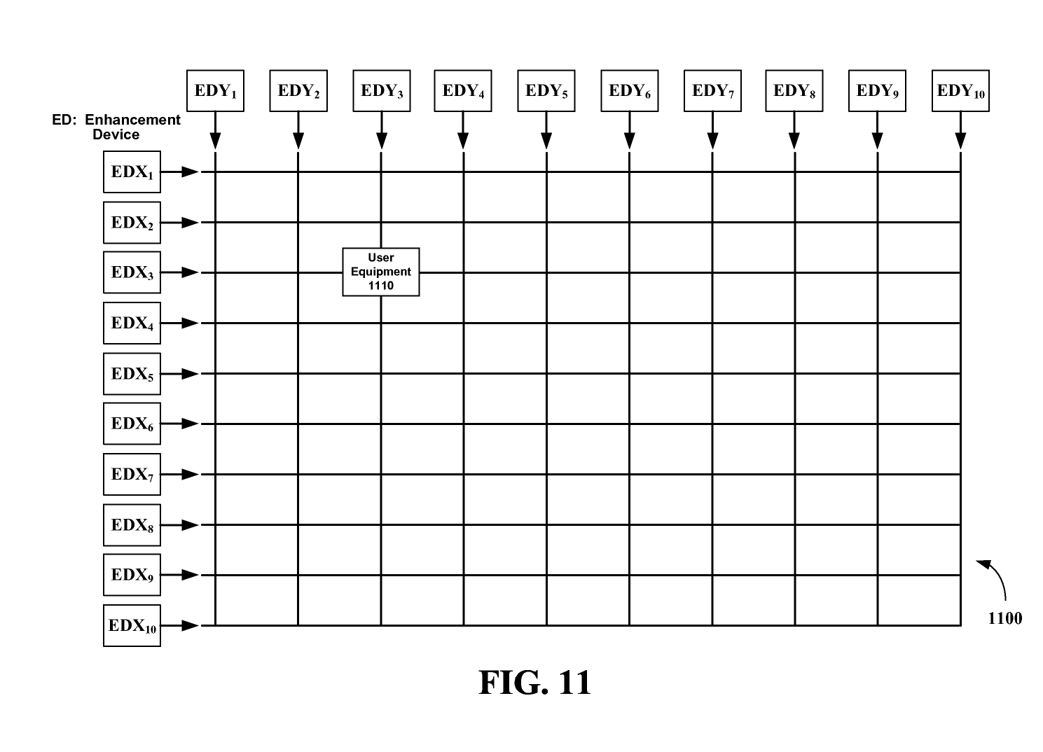

In addition to, or as an alternative to transmit power patterns, directional antennas (e.g. parabolic) may also be used to obtain better positioning estimates. These devices could be used in different configurations to improve positioning, particularly indoors. An exemplary configuration of such embodiment is provided in FIG. 11. As illustrated, user equipment 1110 may be located within a room or a mall 1100 configured as a rectangular grid. For this particular example, there are ten positioning reference signal (PRS) transmitters (i.e., enhancement devices) beaming in the X direction and ten PRS transmitters beaming in the Y direction. By finding the strongest X transmitter and the strongest Y transmitter, an estimated position of user equipment 1110 may be obtained. Here, for example, user equipment 1110 may be estimated to be at the coordinates denoted by Device EDX3 and Device EDY3 (assuming Device EDX3 was the strongest in the x-direction and Device EDY3 was the strongest in the y-direction). This configuration may be desirable since such configuration would likely require far fewer transmitters than a configuration based on nearest cell, which would require one hundred transmitters in the same example.

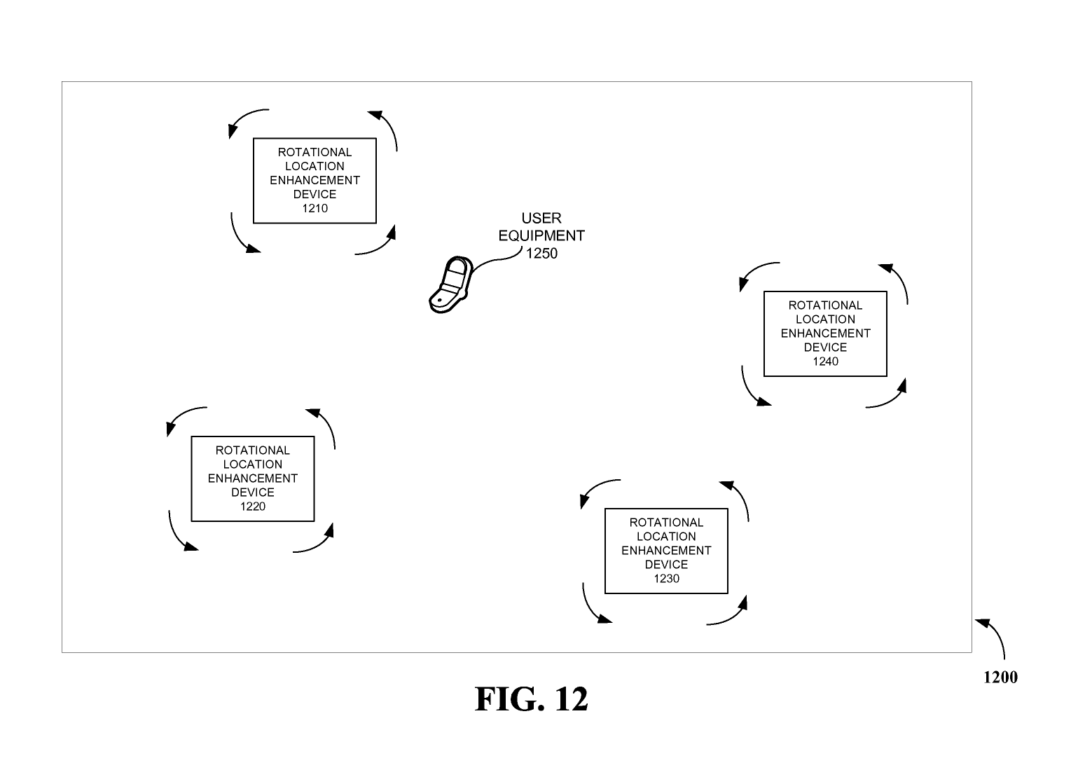

An alternate approach would be to have a rotating antenna (similar to radar) at each transmitter, as illustrated in FIG. 12. As shown, user equipment 1250 may be located in a room 1200 comprising a plurality of rotational location enhanced devices 1210, 1220, 1230, and 1240. Within such embodiment the location of user equipment 1250 may be based on the angles at which user equipment 1250 sees the highest signal strength from each of the transmitters of rotational location enhanced devices 1210, 1220, 1230, and 1240.

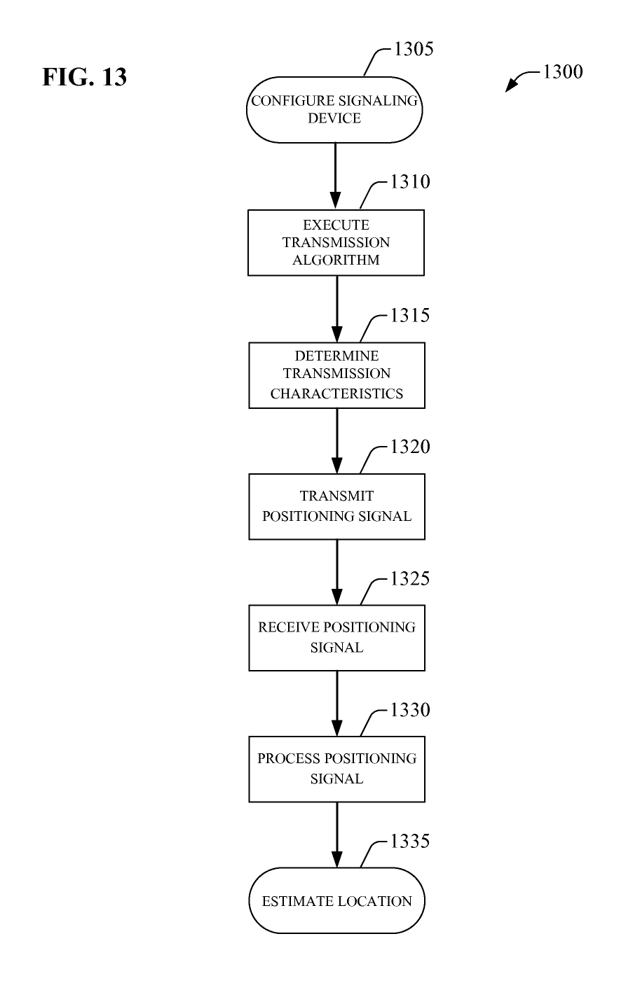

Referring next to FIG. 13, a flow chart illustrating an exemplary method for facilitating proximity detection is provided. As illustrated, process 1300 includes a series of acts that may be performed by various components of a wireless network according to an aspect of the subject specification. Process 1300 may be implemented by employing at least one processor to execute computer executable instructions stored on a computer readable storage medium to implement the series of acts. In another embodiment, a computer-readable storage medium comprising code for causing at least one computer to implement the acts of process 1300 are contemplated.

In an aspect, process 1300 begins with the configuration of a signaling device at act 1305. Here, it should be noted that the signaling device may be any of various types of devices. For instance, the signaling device may be a location enhancement device, a peer-to-peer transmitter, HeNB, etc.

Next, at act 1310, the signaling device executes a particular transmission algorithm. For this embodiment, the transmission algorithm dictates a transmit power and direction for transmitting a positioning signal. Moreover, the transmission algorithm is configured to determine how a positioning signal will be generated and/or transmitted.

Upon executing the transmission algorithm, process 1300 proceeds to act 1315 where transmission characteristics are determined based on the transmission algorithm. In an aspect, as stated previously, the transmit power of the positioning signal may be based on a particular application and/or may vary according to a pre-determined pattern. Also, with respect to direction, the transmission algorithm may dictate whether to activate a particular directional/rotational antenna. The positioning signal is then transmitted at act 1320.

Process 1300 then continues at act 1325 where the transmitted positioning signal is detected by a wireless terminal Upon receiving the positioning signal, the wireless terminal proceeds by processing the positioning signal at act 1330. Here, as stated previously, such processing may include extracting a unique identifier embedded within the positioning signal, as well as taking power measurements of the positioning signal. Process 1300 then concludes at act 1335 where a location of the wireless terminal is estimated based on characteristics of the positioning signal ascertained at act 1330. For instance, a location estimate can be ascertained by associating extracted unique identifiers with devices known to transmit positioning signals in a particular direction (e.g., by associating the transmit powers of particular devices arranged in a grid, as illustrated in FIG. 11).

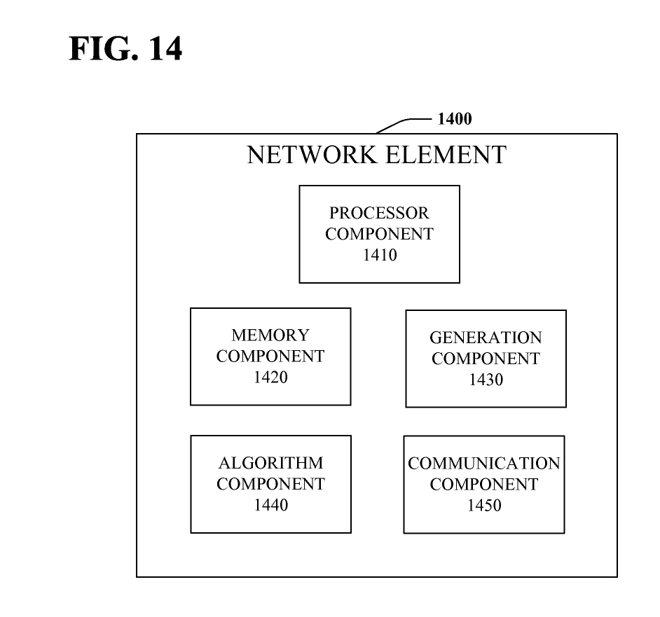

Referring next to FIG. 14, a block diagram illustrates an exemplary network element that facilitates proximity detection in accordance with various aspects. Here, although the network element may reside in a location enhancement device, one of ordinary skill will appreciate that the network element may reside in any of various types of wireless network components/nodes. As illustrated, network element 1400 may include processor component 1410, memory component 1420, generation component 1430, algorithm component 1440, and communication component 1450.

Similar to processor components 710 and 910 in location enhancement device 700 and wireless terminal 900, respectively, processor component 1410 is configured to execute computer-readable instructions related to performing any of a plurality of functions. Processor component 1410 can be a single processor or a plurality of processors dedicated to analyzing information to be communicated from network element 1400 and/or generating information that can be utilized by memory component 1420, generation component 1430, algorithm component 1440, and/or communication component 1450. Additionally or alternatively, processor component 1410 may be configured to control one or more components of network element 1400.

In another aspect, memory component 1420 is coupled to processor component 1410 and configured to store computer-readable instructions executed by processor component 1410. Memory component 1420 may also be configured to store any of a plurality of other types of data including data generated by any of generation component 1430, algorithm component 1440, and/or communication component 1450. Here, it should be noted that memory component 1420 is analogous to memory components 720 and 920 in location enhancement device 700 and wireless terminal 900, respectively. Accordingly, it should be appreciated that any of the aforementioned features/configurations of memory component 720 and/or 920 are also applicable to memory component 1420.

In yet another aspect, network element 1400 also includes generation component 1430 and algorithm component 1440. For this embodiment, generation component 1430 is configured to create a positioning signal, whereas algorithm component 1440 is configured to implement an algorithm to ascertain a transmit power and direction for the positioning signal. For instance, algorithm component 1440 may be configured to implement an application-based algorithm, wherein the application-based algorithm is configured to control the transmit power based on a particular application. In another embodiment, algorithm component 1440 may be configured to implement a pattern-based algorithm to vary the transmit power, wherein the varying is based on a particular transmit pattern.

In a further aspect, network element 1400 includes communication component 1450, which is coupled to processor component 1410 and configured to interface network element 1400 with external entities. For instance, communication component 1450 may be configured to broadcast the positioning signal based on the transmit power and direction. In a particular embodiment, communication component 1450 is further configured to advertise the transmit power to external entities, wherein such advertising may expedite proximity detection processing at a wireless terminal For other embodiments, communication component 1450 may be configured to facilitate broadcasting the positioning signal via any of various types of antennas. For instance, it is contemplated that communication component 1450 may be configured to facilitate broadcasts via a directional antenna and/or rotational antenna, as discussed previously.

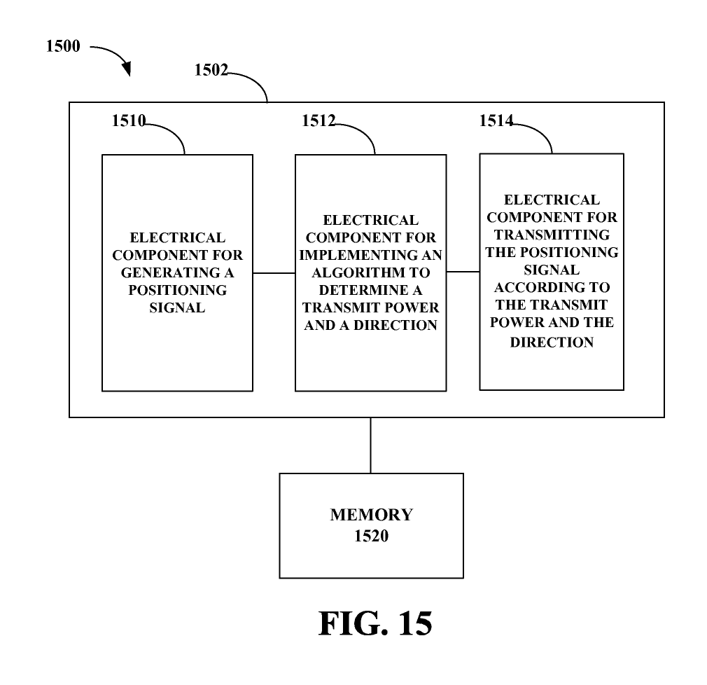

Referring next to FIG. 15, illustrated is a system 1500 that facilitates proximity detection according to an embodiment. System 1500 and/or instructions for implementing system 1500 can physically reside within a network element (e.g., network element 1400) or computer-readable storage medium, for instance, wherein system 1500 includes functional blocks that can represent functions implemented by a processor, software, or combination thereof (e.g., firmware). Moreover, system 1500 includes a logical grouping 1502 of electrical components that can act in conjunction similar to logical groupings 802 and 1002 in systems 800 and 1000, respectively. As illustrated, logical grouping 1502 can include an electrical component for generating a positioning signal 1510. Furthermore, logical grouping 1502 can include an electrical component for implementing an algorithm to determine a transmit power and a direction 1512. Logical grouping 1502 can also include an electrical component for transmitting the positioning signal according to the transmit power and the direction 1514. Additionally, system 1500 can include a memory 1520 that retains instructions for executing functions associated with electrical components 1510, 1512, and 1514. While shown as being external to memory 1520, it is to be understood that electrical components 1510, 1512, and 1514 can exist within memory 1520.

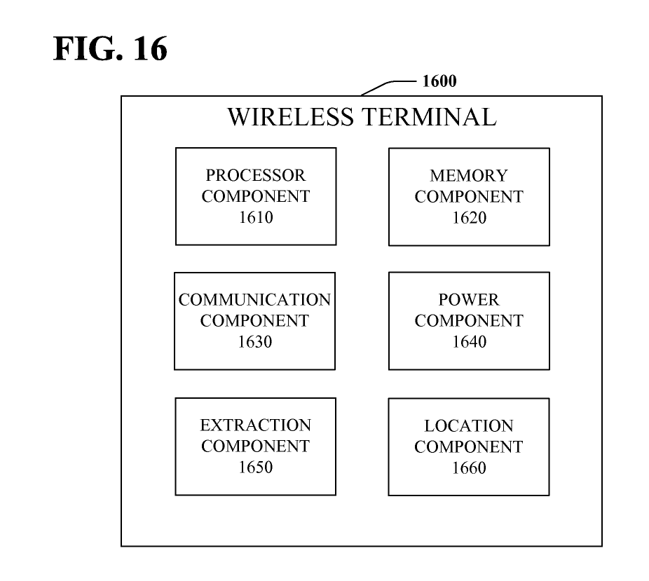

Referring next to FIG. 16, a block diagram illustrates an exemplary wireless terminal that facilitates proximity detection in accordance with various aspects. As illustrated, wireless terminal 1600 may include processor component 1610, memory component 1620, communication component 1630, power component 1640, extraction component 1650, and location component 1660.

Similar to processor components 710, 910, and 1410 in location enhancement device 700, wireless terminal 900, and network element 1400, respectively, processor component 1610 is configured to execute computer-readable instructions related to performing any of a plurality of functions. Processor component 1610 can be a single processor or a plurality of processors dedicated to analyzing information to be communicated from wireless terminal 1600 and/or generating information that can be utilized by memory component 1620, communication component 1630, power component 1640, extraction component 1650, and/or location component 1660. Additionally or alternatively, processor component 1610 may be configured to control one or more components of wireless terminal 1600.

In another aspect, memory component 1620 is coupled to processor component 1610 and configured to store computer-readable instructions executed by processor component 1610. Memory component 1620 may also be configured to store any of a plurality of other types of data including data generated by any of communication component 1630, power component 1640, extraction component 1650, and/or location component 1660. Here, it should be noted that memory component 1620 is analogous to memory components 720, 920, and 1420 in location enhancement device 700, wireless terminal 900, and network element 1400, respectively. Accordingly, it should be appreciated that any of the aforementioned features/configurations of memory component 720, 920, and/or 1420 are also applicable to memory component 1620.

In yet another aspect, wireless terminal 1600 also includes communication component 1630, which is coupled to processor component 1610 and configured to interface wireless terminal 1600 with external entities. For instance, communication component 1630 may be configured to receive a positioning signal and subsequently communicate measured/extracted characteristics associated with the positioning signal (e.g., a unique identifier, a received transmission power, etc.) to an external entity.

As illustrated, wireless terminal 1600 may also include power component 1640. Within such embodiment, power component 1640 is configured to measure a received transmission power of the positioning signal. Here, it should be noted that power component 1640 may be configured to process the received transmission power in any of various ways. For instance, power component 1640 may be configured to ascertain a variation in the received transmission power. Power component 1640 may also be configured to ascertain an advertised transmission power for embodiments in which the transmitting entity advertises its transmission power.

In another aspect, wireless terminal 1600 further includes extraction component 1650 and location component 1660. Within such embodiment, extraction component 1650 is configured to extract particular characteristics from the positioning signal, the at least one characteristic associated with a direction of the positioning signal, whereas location component 1660 is configured to facilitate locating wireless terminal 1600 based on the at least one characteristic and the received transmission power. Here, it should be noted that the characteristics extracted from the positioning signal may, for example, include a unique identifier. For such embodiment, the unique identifier may be associated with the particular entity that transmitted the positioning signal (e.g., a location enhancement device). In another embodiment, it should be further noted that location component 1660 may be configured to associate the extracted characteristics with at least one of a directional antenna or a rotational antenna.

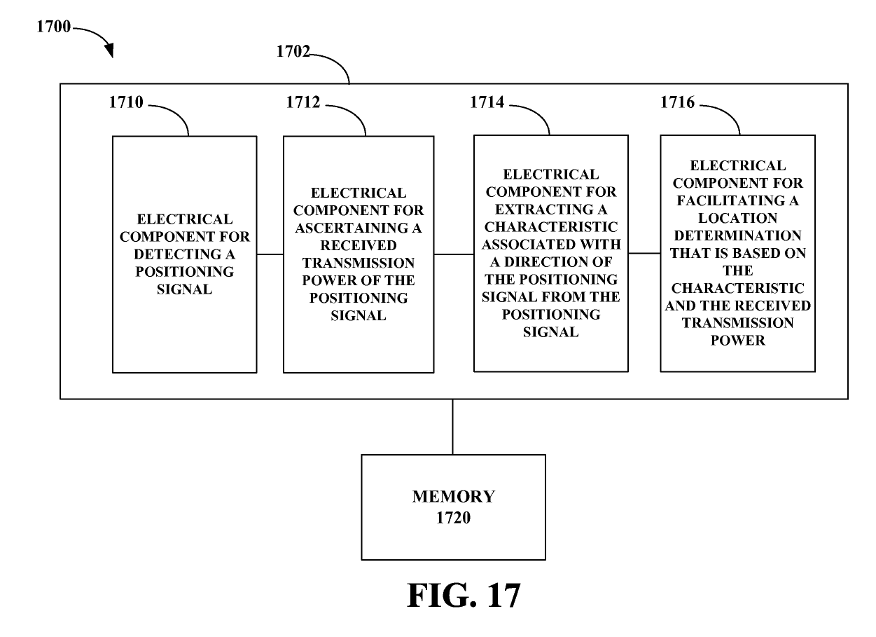

Referring next to FIG. 17, illustrated is a system 1700 that facilitates proximity detection from a wireless terminal according to an embodiment. System 1700 and/or instructions for implementing system 1700 can physically reside within a wireless terminal (e.g., wireless terminal 1600) or computer-readable storage medium, for instance, wherein system 1700 includes functional blocks that can represent functions implemented by a processor, software, or combination thereof (e.g., firmware). Moreover, system 1700 includes a logical grouping 1702 of electrical components that can act in conjunction similar to logical groupings 802, 1002, and 1502 in systems 800, 1000, and 1500, respectively. As illustrated, logical grouping 1702 can include an electrical component for detecting a positioning signal 1710, as well as an electrical component for ascertaining a received transmission power of the positioning signal 1712. Logical grouping 1702 can also include an electrical component for extracting a characteristic associated with a direction of the positioning signal from the positioning signal 1714. Further, logical grouping 1702 can include an electrical component for facilitating a location determination that is based on the characteristic and the received transmission power 1716. Additionally, system 1700 can include a memory 1720 that retains instructions for executing functions associated with electrical components 1710, 1712, 1714, and 1716. While shown as being external to memory 1720, it is to be understood that electrical components 1710, 1712, 1714, and 1716 can exist within memory 1720.

### Exemplary Communication System

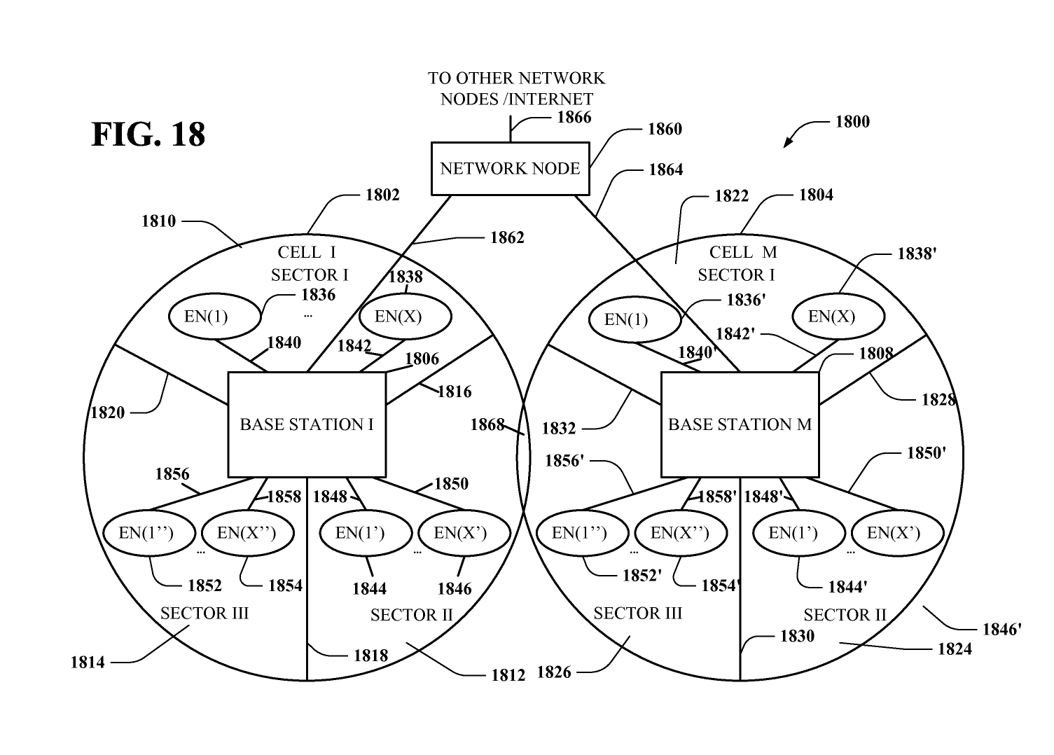

Referring next to FIG. 18, an exemplary communication system 1800 implemented in accordance with various aspects is provided including multiple cells: cell I 1802, cell M 1804. Here, it should be noted that neighboring cells 1802, 1804 overlap slightly, as indicated by cell boundary region 1868, thereby creating potential for signal interference between signals transmitted by base stations in neighboring cells. Each cell 1802, 1804 of system 1800 includes three sectors. Cells which have not been subdivided into multiple sectors (N=1), cells with two sectors (N=2) and cells with more than 3 sectors (N>3) are also possible in accordance with various aspects. Cell 1802 includes a first sector, sector I 1810, a second sector, sector II 1812, and a third sector, sector III 1814. Each sector 1810, 1812, and 1814 has two sector boundary regions; each boundary region is shared between two adjacent sectors.

Sector boundary regions provide potential for signal interference between signals transmitted by base stations in neighboring sectors. Line 1816 represents a sector boundary region between sector I 1810 and sector II 1812; line 1818 represents a sector boundary region between sector II 1812 and sector III 1814; line 1820 represents a sector boundary region between sector III 1814 and sector 1 1810. Similarly, cell M 1804 includes a first sector, sector I 1822, a second sector, sector II 1824, and a third sector, sector III 1826. Line 1828 represents a sector boundary region between sector I 1822 and sector II 1824; line 1830 represents a sector boundary region between sector II 1824 and sector III 1826; line 1832 represents a boundary region between sector III 1826 and sector I 1822. Cell I 1802 includes a base station (BS), base station I 1806, and a plurality of end nodes (ENs) in each sector 1810, 1812, 1814. Sector I 1810 includes EN(1) 1836 and EN(X) 1838 coupled to BS 1806 via wireless links 1840, 1842, respectively; sector II 1812 includes EN(1′) 1844 and EN(X′) 1846 coupled to BS 1806 via wireless links 1848, 1850, respectively; sector III 1814 includes EN(1″) 1852 and EN(X″) 1854 coupled to BS 1806 via wireless links 1856, 1858, respectively. Similarly, cell M 1804 includes base station M 1808, and a plurality of end nodes (ENs) in each sector 1822, 1824, and 1826. Sector I 1822 includes EN(1) 1836′ and EN(X) 1838′ coupled to BS M 1808 via wireless links 1840′, 1842′, respectively; sector II 1824 includes EN(1′) 1844′ and EN(X′) 1846′ coupled to BS M 1808 via wireless links 1848′, 1850′, respectively; sector 3 1826 includes EN(1″) 1852′ and EN(X″) 1854′ coupled to BS 1808 via wireless links 1856′, 1858′, respectively.

System 1800 also includes a network node 1860 which is coupled to BS I 1806 and BS M 1808 via network links 1862, 1864, respectively. Network node 1860 is also coupled to other network nodes, e.g., other base stations, AAA server nodes, intermediate nodes, routers, etc. and the Internet via network link 1866. Network links 1862, 1864, 1866 may be, e.g., fiber optic cables. Each end node, e.g. EN 1 1836 may be a wireless terminal including a transmitter as well as a receiver. The wireless terminals, e.g., EN(1) 1836 may move through system 1800 and may communicate via wireless links with the base station in the cell in which the EN is currently located. The wireless terminals, (WTs), e.g. EN(1) 1836, may communicate with peer nodes, e.g., other WTs in system 1800 or outside system 1800 via a base station, e.g. BS 1806, and/or network node 1860. WTs, e.g., EN(1) 1836 may be mobile communications devices such as cell phones, personal data assistants with wireless modems, etc. Respective base stations perform tone subset allocation using a different method for the strip-symbol periods, from the method employed for allocating tones and determining tone hopping in the rest symbol periods, e.g., non strip-symbol periods. The wireless terminals use the tone subset allocation method along with information received from the base station, e.g., base station slope ID, sector ID information, to determine tones that they can employ to receive data and information at specific strip-symbol periods. The tone subset allocation sequence is constructed, in accordance with various aspects to spread inter-sector and inter-cell interference across respective tones. Although the subject system was described primarily within the context of cellular mode, it is to be appreciated that a plurality of modes may be available and employable in accordance with aspects described herein.

### Exemplary Base Station

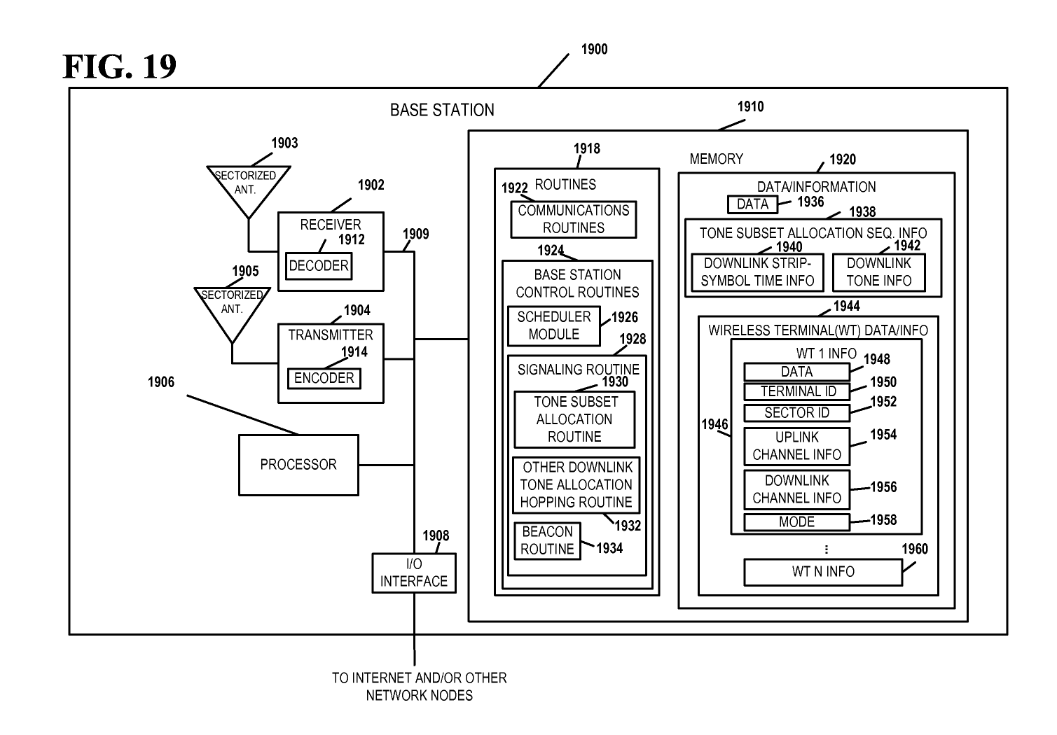

FIG. 19 illustrates an example base station 1900 in accordance with various aspects. Base station 1900 implements tone subset allocation sequences, with different tone subset allocation sequences generated for respective different sector types of the cell. Base station 1900 may be used as any one of base stations 1806, 1808 of the system 1800 of FIG. 18. The base station 1900 includes a receiver 1902, a transmitter 1904, a processor 1906, e.g., CPU, an input/output interface 1908 and memory 1910 coupled together by a bus 1909 over which various elements 1902, 1904, 1906, 1908, and 1910 may interchange data and information.

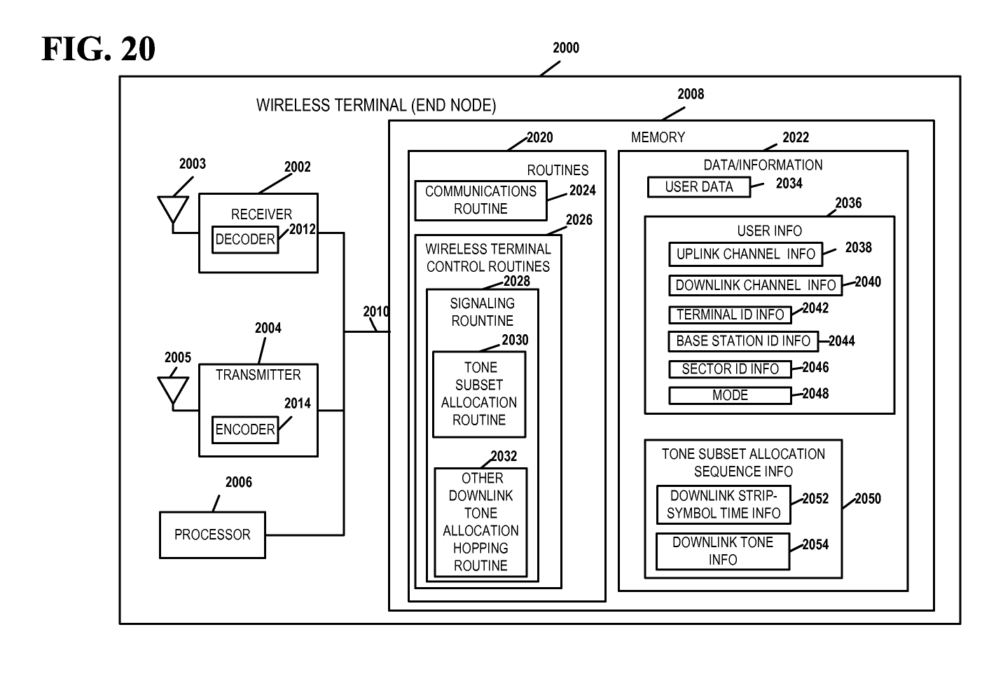

Sectorized antenna 1903 coupled to receiver 1902 is used for receiving data and other signals, e.g., channel reports, from wireless terminals transmissions from each sector within the base station's cell. Sectorized antenna 1905 coupled to transmitter 1904 is used for transmitting data and other signals, e.g., control signals, pilot signal, beacon signals, etc. to wireless terminals 2000 (see FIG. 20) within each sector of the base station's cell. In various aspects, base station 1900 may employ multiple receivers 1902 and multiple transmitters 1904, e.g., an individual receivers 1902 for each sector and an individual transmitter 1904 for each sector. Processor 1906, may be, e.g., a general purpose central processing unit (CPU). Processor 1906 controls operation of base station 1900 under direction of one or more routines 1918 stored in memory 1910 and implements the methods. I/O interface 1908 provides a connection to other network nodes, coupling the BS 1900 to other base stations, access routers, AAA server nodes, etc., other networks, and the Internet. Memory 1910 includes routines 1918 and data/information 1920.

Data/information 1920 includes data 1936, tone subset allocation sequence information 1938 including downlink strip-symbol time information 1940 and downlink tone information 1942, and wireless terminal (WT) data/info 1944 including a plurality of sets of WT information: WT 1 info 1946 and WT N info 1960. Each set of WT info, e.g., WT 1 info 1946 includes data 1948, terminal ID 1950, sector ID 1952, uplink channel information 1954, downlink channel information 1956, and mode information 1958.

Routines 1918 include communications routines 1922 and base station control routines 1924. Base station control routines 1924 includes a scheduler module 1926 and signaling routines 1928 including a tone subset allocation routine 1930 for strip-symbol periods, other downlink tone allocation hopping routine 1932 for the rest of symbol periods, e.g., non strip-symbol periods, and a beacon routine 1934.

Data 1936 includes data to be transmitted that will be sent to encoder 1914 of transmitter 1904 for encoding prior to transmission to WTs, and received data from WTs that has been processed through decoder 1912 of receiver 1902 following reception. Downlink strip-symbol time information 1940 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1942 includes information including a carrier frequency assigned to the base station 1900, the number and frequency of tones, and the set of tone subsets to be allocated to the strip-symbol periods, and other cell and sector specific values such as slope, slope index and sector type.

Data 1948 may include data that WT1 2000 has received from a peer node, data that WT 1 2000 desires to be transmitted to a peer node, and downlink channel quality report feedback information. Terminal ID 1950 is a base station 1900 assigned ID that identifies WT 1 2000. Sector ID 1952 includes information identifying the sector in which WT1 2000 is operating. Sector ID 1952 can be used, for example, to determine the sector type. Uplink channel information 1954 includes information identifying channel segments that have been allocated by scheduler 1926 for WT1 2000 to use, e.g., uplink traffic channel segments for data, dedicated uplink control channels for requests, power control, timing control, etc. Each uplink channel assigned to WT1 2000 includes one or more logical tones, each logical tone following an uplink hopping sequence. Downlink channel information 1956 includes information identifying channel segments that have been allocated by scheduler 1926 to carry data and/or information to WT1 2000, e.g., downlink traffic channel segments for user data. Each downlink channel assigned to WT1 2000 includes one or more logical tones, each following a downlink hopping sequence. Mode information 1958 includes information identifying the state of operation of WT1 2000, e.g. sleep, hold, on.

Communications routines 1922 control the base station 1900 to perform various communications operations and implement various communications protocols. Base station control routines 1924 are used to control the base station 1900 to perform basic base station functional tasks, e.g., signal generation and reception, scheduling, and to implement the steps of the method of some aspects including transmitting signals to wireless terminals using the tone subset allocation sequences during the strip-symbol periods.

Signaling routine 1928 controls the operation of receiver 1902 with its decoder 1912 and transmitter 1904 with its encoder 1914. The signaling routine 1928 is responsible controlling the generation of transmitted data 1936 and control information. Tone subset allocation routine 1930 constructs the tone subset to be used in a strip-symbol period using the method of the aspect and using data/info 1920 including downlink strip-symbol time info 1940 and sector ID 1952. The downlink tone subset allocation sequences will be different for each sector type in a cell and different for adjacent cells. The WTs 2000 receive the signals in the strip-symbol periods in accordance with the downlink tone subset allocation sequences; the base station 1900 uses the same downlink tone subset allocation sequences in order to generate the transmitted signals. Other downlink tone allocation hopping routine 1932 constructs downlink tone hopping sequences, using information including downlink tone information 1942, and downlink channel information 1956, for the symbol periods other than the strip-symbol periods. The downlink data tone hopping sequences are synchronized across the sectors of a cell. Beacon routine 1934 controls the transmission of a beacon signal, e.g., a signal of relatively high power signal concentrated on one or a few tones, which may be used for synchronization purposes, e.g., to synchronize the frame timing structure of the downlink signal and therefore the tone subset allocation sequence with respect to an ultra-slot boundary.

### Exemplary Wireless Terminal

FIG. 20 illustrates an example wireless terminal (end node) 2000 which can be used as any one of the wireless terminals (end nodes), e.g., EN(1) 1836, of the system 1800 shown in FIG. 18. Wireless terminal 2000 implements the tone subset allocation sequences. The wireless terminal 2000 includes a receiver 2002 including a decoder 2012, a transmitter 2004 including an encoder 2014, a processor 2006, and memory 2008 which are coupled together by a bus 2010 over which the various elements 2002, 2004, 2006, 2008 can interchange data and information. An antenna 2003 used for receiving signals from a base station (and/or a disparate wireless terminal) is coupled to receiver 2002. An antenna 2005 used for transmitting signals, e.g., to a base station (and/or a disparate wireless terminal) is coupled to transmitter 2004.

The processor 2006, e.g., a CPU controls the operation of the wireless terminal 2000 and implements methods by executing routines 2020 and using data/information 2022 in memory 2008.

Data/information 2022 includes user data 2034, user information 2036, and tone subset allocation sequence information 2050. User data 2034 may include data, intended for a peer node, which will be routed to encoder 2014 for encoding prior to transmission by transmitter 2004 to a base station, and data received from the base station which has been processed by the decoder 2012 in receiver 2002. User information 2036 includes uplink channel information 2038, downlink channel information 2040, terminal ID information 2042, base station ID information 2044, sector ID information 2046, and mode information 2048. Uplink channel information 2038 includes information identifying uplink channels segments that have been assigned by a base station for wireless terminal 2000 to use when transmitting to the base station. Uplink channels may include uplink traffic channels, dedicated uplink control channels, e.g., request channels, power control channels and timing control channels. Each uplink channel includes one or more logic tones, each logical tone following an uplink tone hopping sequence. The uplink hopping sequences are different between each sector type of a cell and between adjacent cells. Downlink channel information 2040 includes information identifying downlink channel segments that have been assigned by a base station to WT 2000 for use when the base station is transmitting data/information to WT 2000. Downlink channels may include downlink traffic channels and assignment channels, each downlink channel including one or more logical tone, each logical tone following a downlink hopping sequence, which is synchronized between each sector of the cell.

User info 2036 also includes terminal ID information 2042, which is a base station-assigned identification, base station ID information 2044 which identifies the specific base station that WT has established communications with, and sector ID info 2046 which identifies the specific sector of the cell where WT 2000 is presently located. Base station ID 2044 provides a cell slope value and sector ID info 2046 provides a sector index type; the cell slope value and sector index type may be used to derive tone hopping sequences. Mode information 2048 also included in user info 2036 identifies whether the WT 2000 is in sleep mode, hold mode, or on mode.

Tone subset allocation sequence information 2050 includes downlink strip-symbol time information 2052 and downlink tone information 2054. Downlink strip-symbol time information 2052 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 2054 includes information including a carrier frequency assigned to the base station, the number and frequency of tones, and the set of tone subsets to be allocated to the strip-symbol periods, and other cell and sector specific values such as slope, slope index and sector type.

Routines 2020 include communications routines 2024 and wireless terminal control routines 2026. Communications routines 2024 control the various communications protocols used by WT 2000. Wireless terminal control routines 2026 controls basic wireless terminal 2000 functionality including the control of the receiver 2002 and transmitter 2004. Wireless terminal control routines 2026 include the signaling routine 2028. The signaling routine 2028 includes a tone subset allocation routine 2030 for the strip-symbol periods and an other downlink tone allocation hopping routine 2032 for the rest of symbol periods, e.g., non strip-symbol periods. Tone subset allocation routine 2030 uses user data/info 2022 including downlink channel information 2040, base station ID info 2044, e.g., slope index and sector type, and downlink tone information 2054 in order to generate the downlink tone subset allocation sequences in accordance with some aspects and process received data transmitted from the base station. Other downlink tone allocation hopping routine 2030 constructs downlink tone hopping sequences, using information including downlink tone information 2054, and downlink channel information 2040, for the symbol periods other than the strip-symbol periods. Tone subset allocation routine 2030, when executed by processor 2006, is used to determine when and on which tones the wireless terminal 2000 is to receive one or more strip-symbol signals from the base station 1900. The uplink tone allocation hopping routine 2030 uses a tone subset allocation function, along with information received from the base station, to determine the tones in which it should transmit on.

In one or more exemplary embodiments, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

When the embodiments are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method that facilitates proximity detection in a wireless communication network comprising:
activating a location enhancement device;
ascertaining a unique identifier associated with the location enhancement device;
generating a positioning signal that emulates a base station reference signal, the positioning signal including the unique identifier; and
transmitting the positioning signal from the location enhancement device.

2. The method of claim 1, wherein the positioning signal is any of a positioning reference signal, a synchronization signal, a common reference signal, or a system information block (SIB).

3. The method of claim 1, further comprising facilitating a server communication between the location enhancement device and a server.

4. The method of claim 3, further comprising facilitating the server communication via a wireless communication system.

5. The method of claim 3, further comprising facilitating the server communication via a wired communication system.

6. The method of claim 1, wherein the location enhancement device is one of a plurality of location enhancement devices including the location enhancement device and at least one additional location enhancement device, the activating being a function of an activation of the at least one additional location enhancement device.

7. An apparatus configured to facilitate proximity detection in a wireless communication network, the apparatus comprising:
a processor configured to execute computer executable components stored in memory, the components including:
an activation component configured to activate a location enhancement device;
an identifier component configured to determine a unique identifier associated with the location enhancement device;
a generation component configured to provide a positioning signal that emulates a base station reference signal, the positioning signal including the unique identifier; and
a communication component configured to broadcast the positioning signal from the location enhancement device.

8. The apparatus of claim 7, wherein the positioning signal is any of a positioning reference signal, a synchronization signal, a common reference signal, or a system information block (SIB).

9. The apparatus of claim 7, the communication component configured to facilitate a server communication between the location enhancement device and a server.

10. The apparatus of claim 9, the communication component configured to facilitate the server communication via a wireless communication system.

11. The apparatus of claim 9, the communication component configured to facilitate the server communication via a wired communication system.

12. The apparatus of claim 7, wherein the location enhancement device is one of a plurality of location enhancement devices including the location enhancement device and at least one additional location enhancement device, the activation component configured to base an activation of the location enhancement device on a prior activation of the at least one additional location enhancement device.

13. A computer program product that facilitates proximity detection in a wireless communication network, comprising:
a computer-readable storage medium comprising code for causing at least one computer to:
activate a location enhancement device;
determine a unique identifier associated with the location enhancement device;
create a positioning signal that imitates a base station reference signal, the positioning signal including the unique identifier; and
broadcast the positioning signal from the location enhancement device.

14. The computer program product of claim 13, the code further causing the at least one computer to facilitate a server communication between the location enhancement device and a server.

15. An apparatus configured to facilitate proximity detection in a wireless communication network, the apparatus comprising:
means for activating a location enhancement device;
means for associating a unique identifier with the location enhancement device;
means for imitating a base station reference signal with a positioning signal, the positioning signal including the unique identifier; and
means for broadcasting the positioning signal from the location enhancement device.

16. The apparatus of claim 15, wherein the location enhancement device is one of a plurality of location enhancement devices including the location enhancement device and at least one additional location enhancement device, and wherein the means for activating depends on an activation of the at least one additional location enhancement device.

17. A method that facilitates proximity detection in a wireless communication network comprising:
generating a positioning signal;
implementing an algorithm to determine a transmit power and a direction, wherein the algorithm is configured to facilitate determining a wireless terminal location; and
transmitting the positioning signal according to the transmit power and the direction.

18. The method of claim 17, the algorithm comprising controlling the transmit power according to an application.

19. The method of claim 17, the algorithm comprising varying the transmit power.

20. The method of claim 17, the transmitting comprising advertising the transmit power.

21. The method of claim 17, the transmitting facilitated by a directional antenna.

22. The method of claim 17, the transmitting facilitated by a rotational antenna.

23. An apparatus configured to facilitate proximity detection in a wireless communication network, the apparatus comprising:
a processor configured to execute computer executable components stored in memory, the components including:
a generation component configured to create a positioning signal;
an algorithm component configured to implement an algorithm to ascertain a transmit power and a direction, wherein the algorithm is configured to facilitate determining a wireless terminal location; and
a communication component configured to broadcast the positioning signal based on the transmit power and the direction.

24. The apparatus of claim 23, the algorithm component configured to implement an application-based algorithm, wherein the application-based algorithm is configured to control the transmit power based on an application.

25. The apparatus of claim 23, the algorithm component configured to implement a pattern-based algorithm, wherein the pattern-based algorithm is configured to vary the transmit power based on a transmit pattern.

26. The apparatus of claim 23, the communication component configured to advertise the transmit power.

27. The apparatus of claim 23, the communication component configured to facilitate the broadcast via a directional antenna.

28. The apparatus of claim 23, the communication component configured to facilitate the broadcast via a rotational antenna.

29. A computer program product that facilitates proximity detection in a wireless communication network, comprising:
a computer-readable storage medium comprising code for causing at least one computer to:
generate a positioning signal;
execute an algorithm to determine a transmit power and a direction, wherein the algorithm is configured to facilitate ascertaining a wireless terminal location; and
provide the positioning signal according to the transmit power and the direction.

30. The computer program product of claim 29, the code further causing the at least one computer to control the transmit power according to at least one of an application or a transmit pattern.

31. An apparatus configured to facilitate proximity detection in a wireless communication network, the apparatus comprising:
means for creating a positioning signal;
means for implementing an algorithm to determine a transmit power and a direction, wherein the algorithm is configured to facilitate locating a wireless terminal; and
means for broadcasting the positioning signal based on the transmit power and the direction.

32. The apparatus of claim 31, the means for broadcasting including at least one of a directional antenna or a rotational antenna.

33. A method that facilitates proximity detection in a wireless communication network comprising:
receiving a positioning signal from a location enhancement device, the positioning signal emulating a base station reference signal;
extracting a unique identifier from the positioning signal, the unique identifier associated with the location enhancement device;
ascertaining a set of transmission characteristics associated with the positioning signal; and
facilitating a location determination based on at least one of the unique identifier or the set of transmission characteristics.

34. The method of claim 33, the facilitating comprising communicating at least one of the unique identifier or the set of transmission characteristics to a base station.

35. The method of claim 34, further comprising receiving a location from the base station.

36. The method of claim 33, wherein the positioning signal is any of a positioning reference signal, a synchronization signal, a common reference signal, or a system information block (SIB).

37. An apparatus configured to facilitate proximity detection in a wireless communication network, the apparatus comprising:
a processor configured to execute computer executable components stored in memory, the components including:
a receiving component configured to receive a positioning signal from a location enhancement device, the positioning signal emulating a base station reference signal;
an extraction component configured to extract a unique identifier from the positioning signal, the unique identifier associated with the location enhancement device;
a measurement component configured to ascertain a set of transmission characteristics associated with the positioning signal; and
a transmitting component configured to transmit at least one of the unique identifier or the set of transmission characteristics to facilitate determining a location.

38. The apparatus of claim 37, the transmitting component configured to provide the at least one of the unique identifier or the set of transmission characteristics to a base station.

39. The apparatus of claim 38, the receiving component configured to receive an approximate location from the base station.

40. The apparatus of claim 37, wherein the positioning signal is any of a positioning reference signal, a synchronization signal, a common reference signal, or a system information block (SIB).

41. A computer program product that facilitates proximity detection in a wireless communication network, comprising:
a computer-readable storage medium comprising code for causing at least one computer to:
detect a positioning signal transmitted by a location enhancement device, the positioning signal imitating a base station reference signal;
obtain a unique identifier from the positioning signal, the unique identifier associated with the location enhancement device;
determine a set of transmission characteristics associated with the positioning signal; and
facilitate a location determination based on at least one of the unique identifier or the set of transmission characteristics.

42. The computer program product of claim 41, the code further causing the at least one computer to provide at least one of the unique identifier or the set of transmission characteristics to a base station.

43. An apparatus configured to facilitate proximity detection in a wireless communication network, the apparatus comprising:
means for detecting a positioning signal, wherein the positioning signal is broadcast by a location enhancement device, and wherein the positioning signal is emulating a base station reference signal;
means for extracting a unique identifier from the positioning signal, the unique identifier associated with the location enhancement device;
means for measuring a set of transmission characteristics associated with the positioning signal; and
means for communicating at least one of the unique identifier or the set of transmission characteristics.

44. The apparatus of claim 43, wherein the positioning signal is any of a positioning reference signal, a synchronization signal, a common reference signal, or a system information block (SIB).

45. A method that facilitates proximity detection in a wireless communication network comprising:
detecting a positioning signal;
ascertaining a received transmission power of the positioning signal;
extracting a characteristic from the positioning signal, the characteristic associated with a direction of the positioning signal; and
facilitating a location determination, the location determination based on the characteristic and the received transmission power.

46. The method of claim 45, the facilitating comprising communicating the characteristic and the received transmission power to an external entity.

47. The method of claim 45, wherein the characteristic is a unique identifier associated with a transmitter of the positioning signal.

48. The method of claim 45, the ascertaining comprising determining a variation in the received transmission power.

49. The method of claim 45, the ascertaining comprising determining an advertised transmission power.

50. The method of claim 45, the facilitating comprising associating the characteristic with at least one of a directional antenna or a rotational antenna.

51. An apparatus configured to facilitate proximity detection in a wireless communication network, the apparatus comprising:
a processor configured to execute computer executable components stored in memory, the components including:
a communication component configured to receive a positioning signal;
a power component configured to determine a received transmission power of the positioning signal;
an extraction component configured to extract at least one characteristic from the positioning signal, the at least one characteristic associated with a direction of the positioning signal; and
a location component configured to facilitate a location determination, the location determination based on the at least one characteristic and the received transmission power.

52. The apparatus of claim 51, the communication component configured to communicate the at least one characteristic and the received transmission power to an external entity.

53. The apparatus of claim 51, wherein the at least one characteristic is a unique identifier associated with a transmitter of the positioning signal.

54. The apparatus of claim 51, the power component configured to ascertain a variation in the received transmission power.

55. The apparatus of claim 51, the power component configured to ascertain an advertised transmission power.

56. The apparatus of claim 51, the location component configured to associate the at least one characteristic with at least one of a directional antenna or a rotational antenna.

57. A computer program product that facilitates proximity detection in a wireless communication network, comprising:
a computer-readable storage medium comprising code for causing at least one computer to:
receive a positioning signal;
measure a received transmission power of the positioning signal;
ascertain a characteristic from the positioning signal, the characteristic associated with a direction of the positioning signal; and
locate a wireless terminal based on the characteristic and the received transmission power.

58. The computer program product of claim 57, the code further causing the at least one computer to provide the characteristic and the received transmission power to an external entity.

59. The computer program product of claim 57, the code further causing the at least one computer to determine at least one of an advertised transmission power or a variation in the received transmission power.

60. An apparatus configured to facilitate proximity detection in a wireless communication network, the apparatus comprising:
means for detecting a positioning signal;
means for determining a received transmission power of the positioning signal;
means for ascertaining at least one characteristic from the positioning signal, the at least one characteristic associated with a direction of the positioning signal; and
means for locating a wireless terminal based on the at least one characteristic and the received transmission power.

61. The apparatus of claim 60, wherein the at least one characteristic is a unique identifier associated with a transmitter of the positioning signal.

62. The apparatus of claim 60, further comprising means for associating the at least one characteristic with at least one of a directional antenna or a rotational antenna.
